(19) United States
(12) Patent Application Publication
(10) Pub. No.: US 2002/0048018 A1
(43) Pub. Date: Apr. 25, 2002

(54) Method for measuring coma aberration in optical system

(76) Inventor: Masashi Fujimoto, Tokyo (JP)

Correspondence Address: McGinn & Gibb, PLLC, Suite 200, 8321 Old Courthouse Road, Vienna, VA, 22182-3817, US

(21) Appl. No.: 09/981,912

(22) Filed: Oct. 19, 2001

(30) Foreign Application Priority Data
Oct. 20, 2000 (JP) 320153/2000

(51) Int. Cl. G01B 9/00

(52) U.S. Cl. 356/124

(57) ABSTRACT

A coma aberration measuring method which takes the following steps. An object is exposed to light with a mask which bears a plurality of evaluation patterns each having at least two line patterns, wherein the width of lines in each of the plural evaluation patterns is different from that in any of the other evaluation patterns. Alternatively, a plurality of exposures are made on an object with a mask bearing evaluation patterns each having at least two line patterns, while varying the amount of light exposure for each exposure. As a result, a plurality of transfer patterns are created on the object. A detection is made as to in which one or ones among these plural transfer patterns either of the two line patterns is missing. Depending on the magnitude of coma aberration in the optical system used to make exposures, a line pattern with a certain line width among the line patterns to be transferred is not actually transferred. Therefore, the magnitude of coma aberration can be determined according to in which one or ones among the transfer patterns made on the object this phenomenon is observed.

### BACKGROUND OF THE INVENTION

1. Field of the Invention

The present invention relates to an optical system such as a projection exposure device using optical lenses and, more particularly, to a method for measuring a coma aberration known as one of aberrations in such system.

2. Description of Related Art

A coma aberration in an optical system comes about by a light being irradiated obliquely with respect to the optical axis of the lens, resulting in difference in focal position between the center portion of the lens and the peripheral portion thereof. The coma aberration causes an image like a comet as an output through the lens. For this reason, if such coma aberration occurs in a projection exposure device, that is used in process of a semiconductor device to form patterns on a semiconductor wafer, a portion of a fine pattern to be exposed is not resolved on the wafer. The optical systems including the projection exposure device are thus required to correct the lens interval and/or the optical axis of lens according to the coma aberration.

The coma aberration is measured by exposing an evaluation pattern onto a work piece or a target substrate such as a semiconductor wafer. Conventionally, a pattern as shown in FIG. 13(a) has been used as a evaluation pattern. This evaluation pattern PSA consists a plurality of opaque lines which are arranged in parallel to each other with a given width in a given pitch. In this example, five opaque lines L11 to L15 are spaced with the same width in a constant pitch. This evaluation pattern PSA is projected and exposed on a photoresist film coated on the surface of an evaluation wafer by use of a projection exposure system. The photoresist films exposed is then developed. The result is shown in FIG. 13(b) as five resolved lines PL11 to PL15. If the exposure system has the coma aberration, the lines PL11 and PL15 positioning at the both ends are different in width from each other, as indicated by W11 and W15 in FIG. 13(b). This difference between the widths is then measured by a scanning electronic microscope (SEM) or a similar instrument.

In this description, the exposure system producing the actual patterns shown in FIG. 13(b) has such a coma aberration that the tail thereof stretches in the right direction on the drawing, so that the focus on the right side of the pattern is more out of range than on the left side. As a result, the width W15 of the rightmost line PL15 becomes smaller than the width W11 of the leftmost line PL11, as shown in FIG. 13(b). The difference between the widths W15 and W11 is measured to evaluate the coma aberration. The measurement result is then fed back to the exposure system.

However, it is considerably burdensome to measure such a tiny difference in width between the lines PL11 and PL15. In addition, the coma aberration may vary depending on the positions within a one-shot exposure area or a single chip area. For this reason, evaluation pattern is required to be formed at a plurality of places within the one-shot exposure area, and the above difference measurement have to be done at the respective places. Thus, the measurement work requires a lot of steps and is complicated.

In order to solve such problems, Japanese Laid-open (Kokai) Patent Publication Hei 11-354411 proposes an improved coma aberration measuring technique. In this technique, an evaluation mask is prepared which has two openings, and light is then irradiated to pass through one of the openings with interaction of such a phase shift mask that shifts the phase of the light by 180 degrees. As to the other opening, the light passes there through without such phase shift mask. As a result, it is possible to obtain the width difference twice as large as the width difference shown in FIG. 13(b). The measurement thus becomes relatively easy.

Since this technique require the step of measuring the width difference, however, it is basically the same as FIG. 13. The highly accurate method of measuring is required. Moreover, the provision of a phase shift mask is needed.

Another measuring method is suggested by Japanese Kokai Patent Publication Hei 11-142108, which utilizes the above coma asymmetry and the transfer deviation in position caused by the different degrees of pattern density, specifically, cyclic patterns composed of unit patterns are transferred and a line-symmetrically arranged pattern for extracting a given number of cyclic patterns in the middle of the above cyclic pattern area is transferred and then the outer and inner edge positions of the remaining cyclic pattern area are measured to find a positional difference between the edge centers for evaluation of a coma aberration. This technique is effective in facilitating production and measurement processes because it just requires measurement of cyclic pattern outer and inner edge positions and the center positions of both edge positions, namely it eliminates the need for formation of micro-patterns and measurement of their widths as required in the above-mentioned conventional method.

However, this technique requires two steps of exposure: one for transfer of cyclic patterns and the other for transfer of line-symmetric patterns. It is further necessary to determine the relative positions of the cyclic and line-symmetric patterns. For this reason, the number of steps is increased and the measurement work is made troublesome.

### SUMMARY OF THE INVENTION

It is an object of the present invention to provide a further improved method for coma aberration measurement.

Another object of the present invention is to provide a method for coma aberration measurement which saves steps and time.

A further object of the present invention is to provide a method for coma aberration measurement which is done in high accuracy while reducing the number of hours for measurement.

A yet another object of the present invention is to provide an method for measuring coma aberration of a reduction projection exposure system used in producing semiconductor devices.

In the measuring method according to the present invention, projected and exposed onto a target substrate such as a semiconductor wafer. This evaluation pattern has at least two opaque or impermeable line patterns, and a plurality of this evaluation pattern are transferred on the target. Subsequently the patterns thus transferred(hereinafter referred to as “transferred patterns”) are subjected to a measurement process. In this measurement process, it is detected which one or ones among the transferred patterns are brought into such a condition that any one of the above two opaque lines disappears, and it is further detected which one of the two opaque lines disappears.

In accordance with the degree of the coma aberration, a pattern actually transferred or formed on the target becomes smaller and smaller and finally disappears. The direction in which pattern becomes small depends on the direction in which the coma aberration occurs. The present inventor has directed his attention to this fact or nature of the transferred patterns influenced by the coma aberration. Specifically, as described above, a plurality of evaluation patterns each having at least two light-impermeable line patterns are transferred onto the target, and thereafter the inspection is made to lean which one or ones among the transferred patterns is missing one of the two light-impermeable line patterns, and further to learn which one of the line patterns disappears or has not been transferred. Thus, the orientation and degree or amount of the coma aberration can be evaluated according to which transferred pattern has incomplete line patterns.

In a preferred embodiment of the present invention, a plurality of the above evaluation patterns are formed on a single mask and transferred at a time onto an imaging object through a single shot of exposure. In this case, it is preferable that the widths of the two line patterns in each evaluation pattern are the same as each other but are different among the plural evaluation patterns. Since the width difference is designed with a specific relationship between evaluation patterns, the amount of coma aberration can be easily detected according to which evaluation pattern is actually formed in completely.

In another preferred embodiment of the present invention, an evaluation pattern is transferred to a plurality of locations on the target while varying the light exposure amount for each shot so that a plurality of the transferred patterns are made on the target. In this process, the evaluation pattern is exposed one by one in sequence while the amount of light exposure is being varied every shot, the widths of the transferred line patterns is determined by the exposure amount as well as the coma aberration.

The method according to the present invention is preferably applied, for the purpose of compensating the coma aberration, to a projection exposure system, particularly a reduction projection exposure system called a stepper, that is used to manufacture semiconductor devices which requires fine patterns.

### BRIEF DESCRIPTION OF THE DRAWINGS

The above and other objects, advantages and features of the present invention will be more apparent from the following description taken in conjunction with the accompanying drawings, in which:

FIG. 1 conceptually shows the structure of a projection exposure device for fabrication of semiconductor devices in which coma aberration measurement is made according to the present invention;

FIG. 2 shows an evaluation mask used in a first embodiment of the present invention;

FIGS. 3(a) and 3(b) show details of some part of what is shown in FIG. 2;

FIG. 4 shows a transfer made on a wafer from the evaluation pattern on the mask as shown in FIG. 2;

FIGS. 5(a) to 5(e) show details of some part of what is shown in FIG. 4;

FIGS. 6(a) and 6(b) show relative positional deviations of lines obtained from a transferred pattern image, from a reference line pair;

FIG. 7 is a graph showing the relation between the measured line widths and relative positional deviations;

FIG. 8 is a graph showing the relation between line widths and coma aberrations;

FIG. 9 shows an evaluation mask used in a second embodiment of the present invention;

FIGS. 10(a) to 10(e) show transfers made on a wafer from the mask as shown in FIG. 9 according to a second embodiment of the present invention;

FIG. 11 is a graph showing the relation between light exposures and relative positional deviations which is obtained from measurements of the transfer patterns as shown in FIG. 9;

FIG. 12 is a graph showing the relation between light exposures and coma aberration magnitudes; and

FIGS. 13(a) and 13(b) show patterns used in a conventional coma aberration measuring method.

### DETAILED DESCRIPTION OF THE PREFERRED EMBODIMENTS

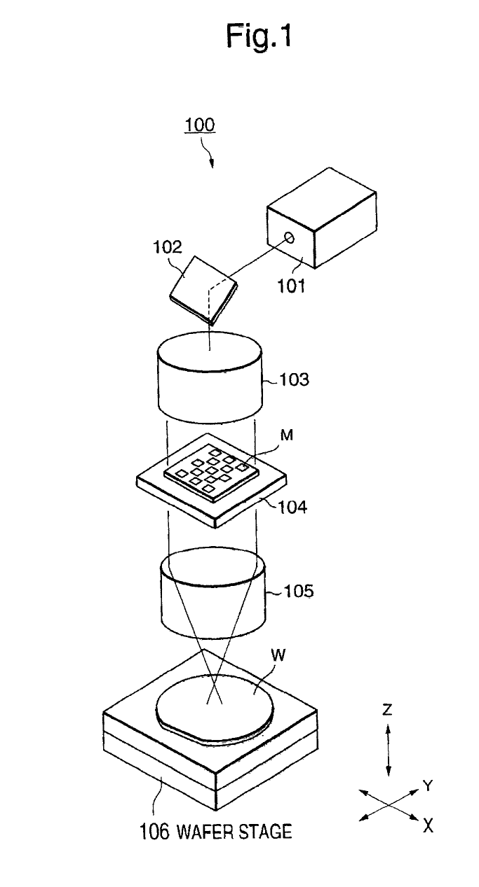

FIG. 1 illustrates a projection exposure device 100 used for fabrication of semiconductor devices as an optical system used in the present invention. This projection exposure device 100 is composed of the following: a KrF excimer laser 101; a reflection mirror 102 which reflects laser light emitted from the KrF excimer laser 101; a lighting optical system 103 for illuminating an evaluation mask (photo mask) M placed on a mask stage 104 with reflected laser light; a reduction type projection optical system (projection lens) 105 located beneath the mask stage 104, for which a coma aberration is measured; and a wafer stage 106 for an evaluation wafer Won which an evaluation pattern (stated later) on the evaluation mask M is exposed through the projection optical system 105, is placed. The evaluation pattern is focused onto the surface of the evaluation wafer W in reduced form by means of the projection optical system 105. The surface of the evaluation wafer W is coated with photoresist (not shown in the figure); the evaluation pattern appears as a photoresist pattern after developing the photoresist. The wafer stage 106 is movable in X/Y directions on a plane as indicated by the arrows in the figure; evaluation pattern exposures can be executed in a step-and-repeat mode on a chip-by-chip basis. The wafer stage 106 can be moved in the direction of the optical axis of the projection optical system 105 (Z direction) in order to bring the evaluation pattern into focus on the surface of the evaluation wafer W.

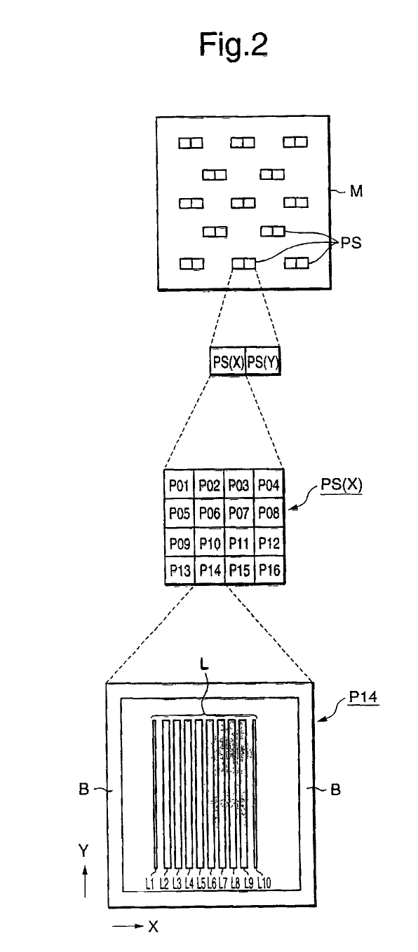

In the measuring method according to a first embodiment of the present invention, the evaluation mask M is as shown in FIG. 2. In this embodiment, in order to measure coma aberration by a single shot of exposure, the mask contains a plurality of evaluation patterns PS. The evaluation mask M is projected and exposed as a single chip by the single shot of exposure through the projection exposure device 100 as shown in FIG. 1. The evaluation patterns PS are formed on the surface of a transparent substrate used by the evaluation mask M, wherein the patterns are made of foils of metal which is opaque or does not transmit light, such as chrome (details of the patterns are not shown in the figure). These patterns are distributed appropriately all over the surface area of the evaluation mask M where at least one of patterns is on its optical axis center position. Regarding the number of evaluation patterns PS and their positions, it is preferable to have at least five patterns in a one-shot area (almost the same dimension as the evaluation mask M) including four around the four corners and one in the center for the purpose of observing the distribution of coma aberration within one shot. It is more desirable to have measuring points (patterns) as many as possible in order to obtain accurate distribution; however, it means a longer measuring time. In this embodiment, thirteen evaluation patterns PS are distributed within the one-shot area. As shown in the figure, they are aligned at nearly regular intervals along the X and Y directions. Patterns may also be aligned radially along concentric circles with the mask M's center as the center of the circles.

One evaluation pattern PS consists of a pair of patterns: a pattern PS(X) for coma aberration in the X direction and a pattern PS(Y) for coma aberration in the Y direction. The difference between these patterns will be explained later.

In this embodiment, pattern PS(X) consists of sixteen patterns P01 to P16 in four rows and four columns: each of these patterns are called an L/S (line/space) pattern. Referring to L/S pattern P14 as a representative of the L/S patterns, each L/S pattern includes a line portion L composed of plural light-impermeable lines aligned along the X direction with spaces between lines. Although at least two lines are indispensable, the more lines, the longer the length of the line portion in the X direction, which makes measurement easier. However, if too many lines are used, each size of evaluation patterns becomes large which is no longer treated as a point for measurement. Taking this disadvantage into consideration, the desirable number of lines is from 10 to 15. In this embodiment, each L/S pattern has ten lines L1 to L10.

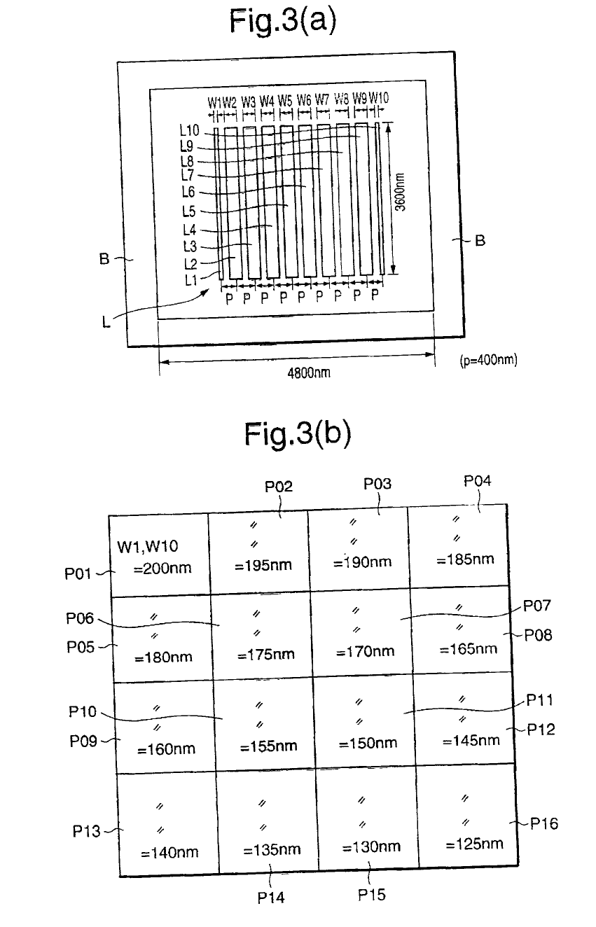

These LS patterns are further explained as follows: as shown in FIG. 3(a), lines L1 to L10 are approximately 3600 nm long in the Y direction and evenly spaced with a pitch of 400 nm in the X direction. The eight middle lines L2 to L9 have an equal line width of 200 nm (W2 to W9). This middle line width is identical among all L/S patterns P01 to P16. On the other hand, the line width (W1 and W10) of the two lines at both ends L1 and L10 is equal to or smaller than the line width W2 to W9; the line width of these two lines is expressed as W′. This line width W′ is different to each other among L/S patterns P01 to P16. As mentioned earlier, each L/S pattern should have at least two lines; these lines L1 and L10 correspond to the minimum required two lines. In the case of L/S pattern P14 as shown in FIG. 2, the width W1, W10 of lines L1 and L10 is 135 nm.

In each of LS patterns P01 to P16, the line L portion is located between a pair of reference lines B facing each other in the X direction (namely, each extending in the Y direction). In this embodiment, reference lines B as a pair are connected by patterns extending in the X direction. Concretely, a rectangular light-impermeable frame with X and Y dimensions of approx. 4800 nm is formed and the inner edges of the frame which are spaced in the X direction and opposite to each other are treated as a pair of reference lines B, between which the line portion L lies. The center of the line portion L in the X direction is identical to that of the pair B. The lines connecting the pairing reference lines B are omissible. Also in the configuration as shown in the figure, the pair connecting lines may be connected with lines L.

An example of the state that the width WI of the two lines L1 and L10 at both ends is different to each other among L/S patterns P01 to P16 is shown in FIG. 3(b). Here, the line width W1, W10 of lines L1 and L10 in L/S pattern P01 is the largest, or 200 nm, while that in L/S pattern P16 is the smallest, or 125 nm. For L/S patterns P02 to P16, the line width W1, W10 decreases in a decrement of 5 nm from 200 nm to 125 nm. For example, the line width W1, W10 of lines L1 and L10 in L/S pattern P03 is 190 nm, and that in L/S pattern P10 is 155 nm.

The coma aberration detection pattern PS (Y) which pairs with the coma aberration detection pattern PS(x) is used to detect coma aberration in the Y direction. For this purpose, PS(Y) has L/S patterns P01 to P16 rotated by 90 degrees, so that ten lines L1 to L10 are aligned along the Y direction between a pair of reference lines B.

The evaluation mask M thus designed is placed on the mask stage 104 of the projection exposure device 100 as shown in FIG. 1. Also, an evaluation wafer W with a photoresist coating on its surface is placed on the wafer stage 106. The evaluation mask M is illuminated by the lighting optical system 103 and the evaluation patterns on the evaluation mask M are focused in reduced form onto the surface of the evaluation wafer W by one shot of exposure through the reduction projection optical system 105. The exposed photoresist of the evaluation wafer W is developed.

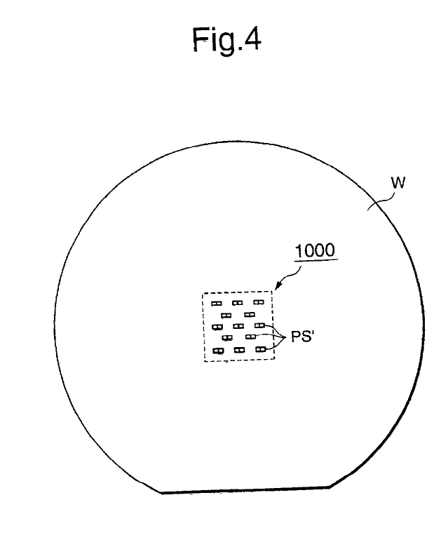

In this way, as shown in FIG. 4, a transferred pattern 1000 is formed on part of the wafer W surface from the evaluation patterns PS of the evaluation mask m. This pattern 1000 contains thirteen transferred evaluation patterns PS′. In case of the degree of coma aberration is not so serious and substantially has no effect on the patterns made by one shot of exposure, all of the ten images/transfers of lines L1 to L10 in every transfer pattern PS′ remain unchanged. If not among L/S patterns P01 to P16, at least in one L/S pattern one or both of the lines L1 and L10 is disappear and also among the thirteen transferred evaluation patterns PS′ there is at least one transferred evaluation pattern have such a pattern.

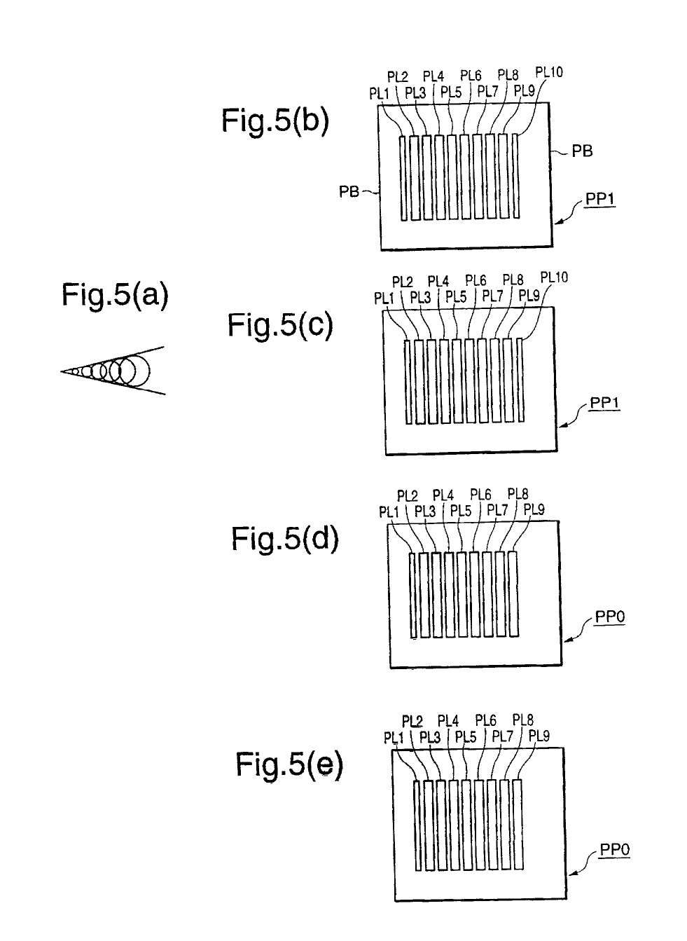

As shown in FIG. 5(a), if in the projection optical system 105 of the exposure device 100 has a coma aberration oriented rightward as you face the figure, two types of transfer patterns will be generated: complete patterns PP1 in which all ten lines L1 to L10 have been transferred as shown in FIGS. 5(b) and 5(c), and incomplete patterns PP0 in which nine lines L1 to L9 except line L10 have been transferred as shown in FIGS. 5(d) and 5(e). If the result of transfer of the pattern P14 shown in FIG. 2 is the pattern shown in FIG. 5(d), the result of transfer of patterns P01 to P13 will be patterns like those shown in FIG. 5(b) or 5(c) and the result of transfer of pattern P15 and P16 will be like that of pattern P14, i.e. the pattern in FIG. 5(d) or 5(e). This is because in case of a coma aberration like the one in FIG. 5(a), the right endpart of an image (which corresponds to the tail of the comet) cannot be formed properly, leading to a failure in transfer of line L10. This phenomenon correlates with the value of coma aberration: the larger the coma aberration value is, the more likely incomplete L/S pattern images PP0 are formed in L/S patterns with larger line widths of W1 and W10. This means that the larger the coma aberration is, the L/S pattern with which an incomplete pattern PP0 begins to generate is closer to P01.

In order to find which L/S pattern begins to generate an incomplete pattern PP0, the evaluation wafer w bearing a transferred pattern 1000 is loaded on a widely used automatic overlay measuring instrument or optical microscope not shown here. When an automatic overlay measuring instrument is used, an L/S pattern image PP is scanned along the direction of line alignment of the line portion L with a light beam; both ends of the line portion L and each end of the reference line pair B in the L/S pattern PP are measured by detecting the amount of reflected light which is decreased by the L/S pattern PP while the scanning, and also the center positions of the line portion L and reference line pair B along the direction of alignment are calculated from the measurement. From the center position CL of pattern images PL1 to PL10 of the line portion L in each of L/S patterns P01 to P16 and the center position CB of the pattern images PB of the reference line pair B, the relative positional deviation Ac is calculated as the difference between the measured center position CL of the line portion L and the measured center position CB of the reference line pair B.

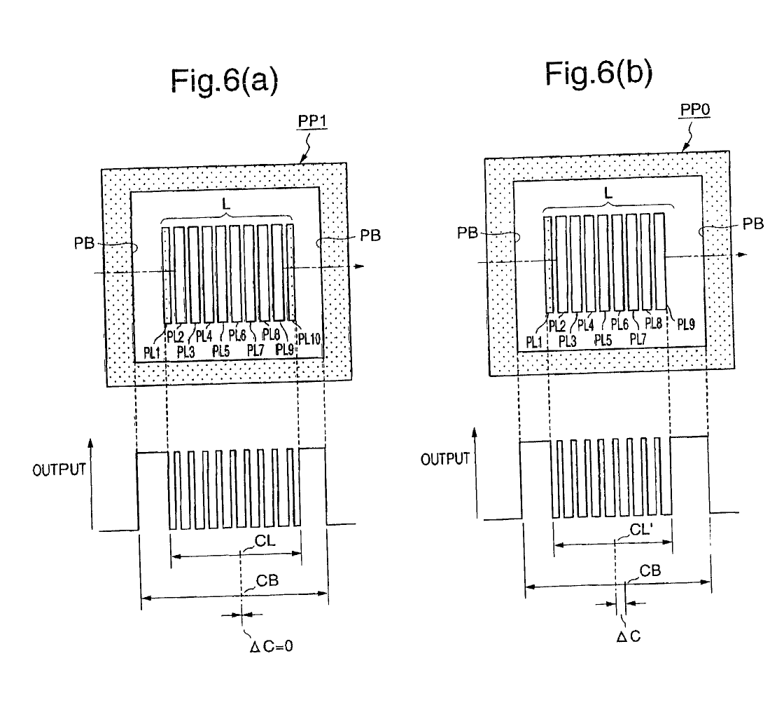

As illustrated in FIG. 6(a), for al complete L/S pattern image PP1 in which all ten lines L1 to L10 appeare as pattern images PL1 to PL10, the center position CL of the line portion L in the direction of alignment virtually coincides with the center position CB of the reference line pair B and therefore the relative positional deviation ΔC of the center position CL from the center position CB is almost zero. In contrast, for an incomplete L/S pattern image PP0 in which a line at one end of the line portion L of an L/S pattern, line L10 in this example, disappears. The center position CL′ should deviate by approximately one half of one pitch (In this case, 400 nm×½=200 nm) from the center position CL for the complete L/S pattern image PP1. On the other hand, the center position CB of the reference line pair B remains unchanged so the relative positional deviation ΔC of the line portion center position CL′ from the reference line pair center position CB should be nearly 200 nm.

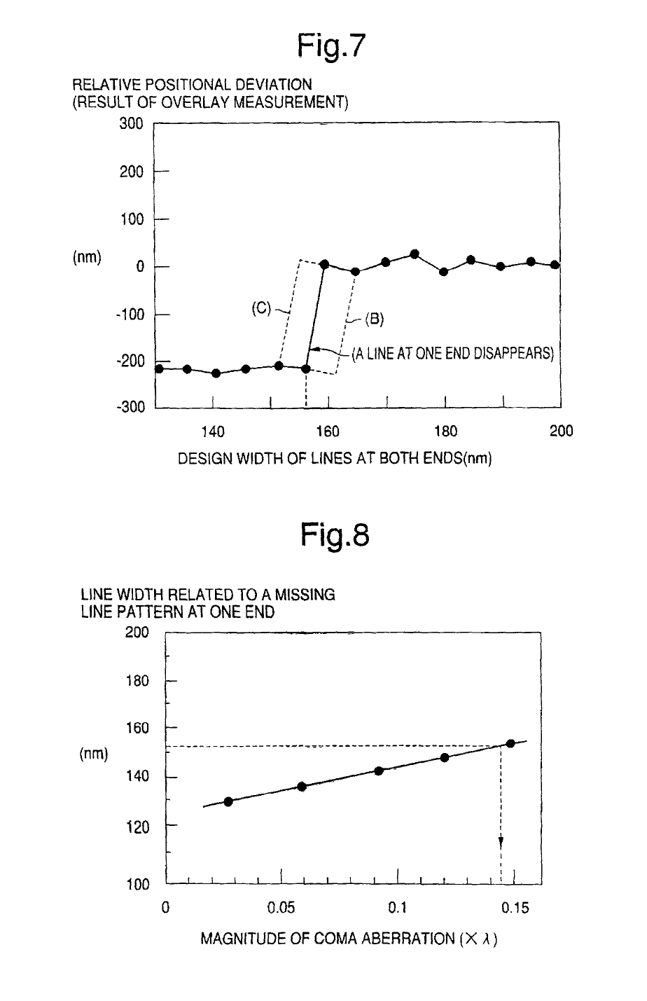

Measurements as mentioned above are made on each of L/S patterns P01 to P16 to find the relative positional deviation ΔC of the center position CL from the center position CB in each pattern. If the image of line L10 begins to disappear in the image of L/S pattern P10, the relative positional deviation ΔC is nearly 200 nm for L/S pattern P10 and P11 to P16 whose width of line L10 is smaller than that of L/S pattern P10; on the contrary, it is nearly zero for L/S patterns P01 to P09, as shown in FIG. 7. From this result, it is found that the coma aberration corresponds to the width W1, W10 of lines L1 and L10 in L/S pattern P10, that is 155 nm.

On the other hand, prior to the above-said measuring process, a step is taken to determine the correlation between the coma aberration values in the projection exposure device 100 in FIG. 1 and the line widths for L/S patterns which produce incomplete L/S pattern images with that coma aberration value, as shown in FIG. 8. This correlation is calculated using a simulator which is used to perform computation for the optical system of the projection exposure device as well as computation of shapes after exposure and development. In other words, using a simulator which computes the optical system while mathematically varying the mask line width, the level of incident light which causes a specific value of coma aberration is calculated; then an L/S pattern image is calculated using a simulator which uses the calculated incident light level as an input to calculate shapes after exposure and development, followed by plotting of a graph which shows mask line widths for incomplete L/S pattern images versus coma aberration values. The result is as shown in FIG. 8. By applying the critical line width as discussed above to this correlation graph, the value of coma aberration is obtained.

The value of coma aberration in the projection optical system differs according to the critical line width for an incomplete L/S pattern image where a line at one end of an L/S pattern line portion L begins to disappear. In the characteristic graph in FIG. 7, in case for a larger coma aberration value, the correlation is represented by broken line B where the critical line width is larger. Conversely, in case for a smaller coma aberration value, it is represented by broken line C where the critical line width is smaller. Therefore, by applying the critical line widths based on the correlation represented by broken lines B and C to the graph in FIG. 8, different coma aberration values will be obtained.

A graph like the one in FIG. 7 can also be obtained by measuring the distance of the line portion L of each L/S pattern (i.e. interval between L0 and L10) and finding an L/S pattern where this distance suddenly begins to change to determine a critical pattern where an incomplete L/S pattern begins.

With the procedures as explained so far, the X component of coma aberration is obtained from the evaluation pattern PS (X) and the Y component of coma aberration is obtained from the evaluation pattern PS(Y). When the above measuring procedures are taken for each of the thirteen transfer evaluation patterns PS′ as shown in FIG. 4, the distribution of coma aberrations within a shot S can be used for system adjustment. The lens arrangement of the projection optical system is adjusted according to this distribution. For instance, if coma aberrations are radially distributed within a shot, the lens interval of the projection optical system should be adjusted; if coma aberrations are distributed in the same direction, the lens optical axis should be adjusted.

As discussed so far, using an evaluation mask M according to this embodiment, a coma aberration can be obtained just by measuring the relative positional deviation ΔC of the center position CL (CL′) of the line portion L of L/S pattern images PP (PP1, PP0) as transferred on the photoresist of the evaluation wafer W, from the center position CB of the reference line pair B. It is not necessary to measure widths of fine lines L1 to L10 constituting an L/S pattern line portion L and individual spaces between these lines. Also when measuring the dimensions of pattern images PP of L/S patterns, it is unnecessary to use a scanning electronic microscope. For this reason, a coma aberration can be evaluated more easily. Moreover, there is no necessity to use a phase shift mask or the like making mask manufacturing process simple. In this aspect, it can be said that this measuring method is simpler than the conventional method.

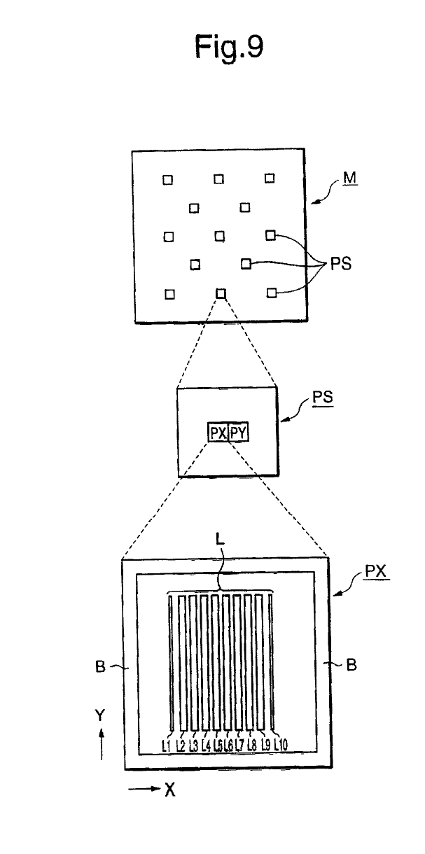

FIG. 9 illustrates an evaluation mask M used for a measuring method according to a second embodiment of the present invention. Like the first embodiment, this evaluation mask M contains thirteen evaluation patterns Ps each of which consists of a pair of patterns, a pattern PX for the X direction and a pattern PY for the Y direction. However, unlike the first embodiment in which each PS pattern has sixteen patterns, each of patterns PX and PY consists of one pattern. Pattern PY is rotated 90-degree with respect to pattern PX. Each L/S pattern PX comprises a line portion L consisting of ten light-impermeable lines L1 to L10 evenly spaced and aligned in the X direction and a pair of reference lines B around the line portion. Like the case as shown in FIG. 3(a), lines L1 to L10 in the line portion L are approximately 3600 nm long in the Y direction and evenly spaced with a pitch of 400 nm in the X direction. The eight middle lines L2 to L9 have an common line width, W2-W9, of 200 nm. The line width W1, W10 of the two lines at both ends of the line portion, L1 and L10, is smaller than the line width W2-W9 of the eight lines L2 to L9; in this case the line width W1, W10 is 150 nm which is around the middle line width in the first embodiment. The center position of lines L1 to L10 is identical to that of the reference line pair B.

The patterns thus designed on the evaluation mask M are transferred to the evaluation wafer W using the projection exposure device 100 as shown in FIG. 1. In this embodiment, exposings are executed on the evaluation wafer W while changing the intensity of light in the lighting optical system 103 which illuminates the mask M with the same interval, i.e. changing the amount of light exposed on the evaluation wafer W. Specifically, a certain amount of light exposure is used to execute an exposing of the evaluation pattern PS on a certain position of the wafer W. then, after moving the wafer stage 106 in the X and/or Y direction, another exposing of the evaluation pattern PS is executed on another position of the wafer using a larger or smaller amount of light exposure than the previous one. These steps are repeated resulting in a plurality of evaluation pattern PS transfers on the wafer. In this particular case, sixteen exposings are executed along the Y axis which passes through the center of the evaluation wafer W, exposing sixteen evaluation patterns PS with changing the amount of the light exposure, as in the first embodiment.

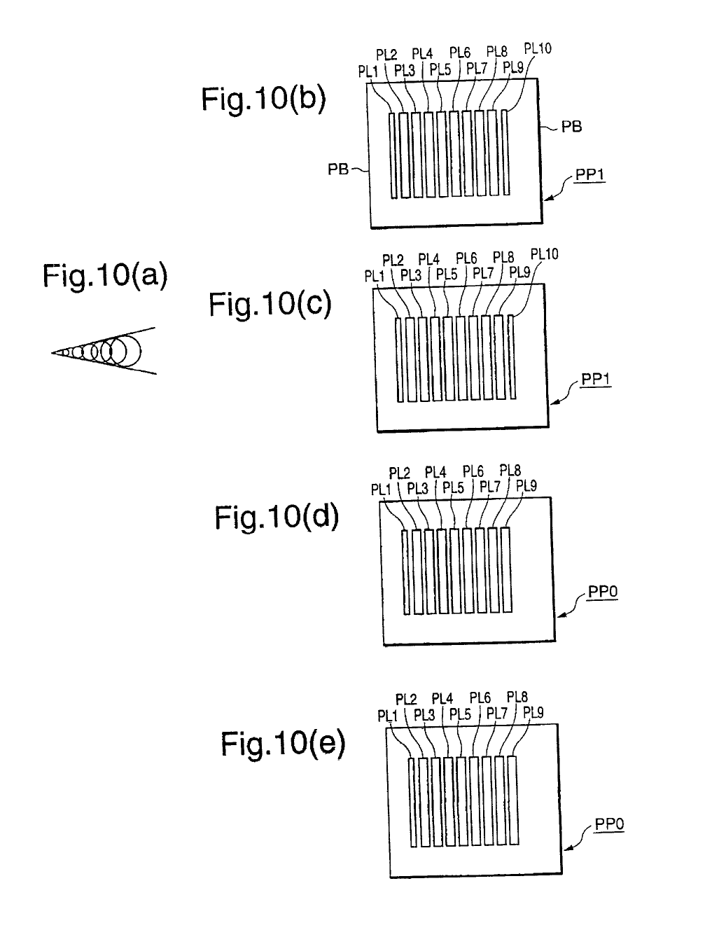

After this, the exposed photoresist of the evaluation wafer W is developed producing images PP of the evaluation patterns PS each of which consists of L/S patterns PX and PY, exposed on the photoresist. Here, if there is a coma aberration in the X direction in the projection optical system 105 as shown in FIG. 10(a), complete or incomplete L/S pattern images appear depending on the coma aberration's asymmetry with respect to the optical axis and the characteristic of the width of line images in conjunction with light exposure. When a proper exposure or under-exposure is used, images of all lines L1 to L10 in the line portion L appear as pattern images PL1 to PL10 to make up a complete L/S pattern image PP1 as shown in FIGS. 10(b) and 10(c). When an over-exposure is used, an image of either of the lines L1 and L10 at both ends (rightmost line L10 in this case) disppears, which means a failure to make up a complete L/S pattern image: namely, as shown in FIGS. 10(d) and 10(e), only pattern images PL1 to PL9 of lines L1 to L9 appear to make up an incomplete L/S pattern image PP0. This indicates that whether an incomplete L/S pattern image PP0 with the absence of an image of one of the-lines L1 and L10 is generated or not does not depend on the level of the coma aberration, but depend on the amount of exposure.

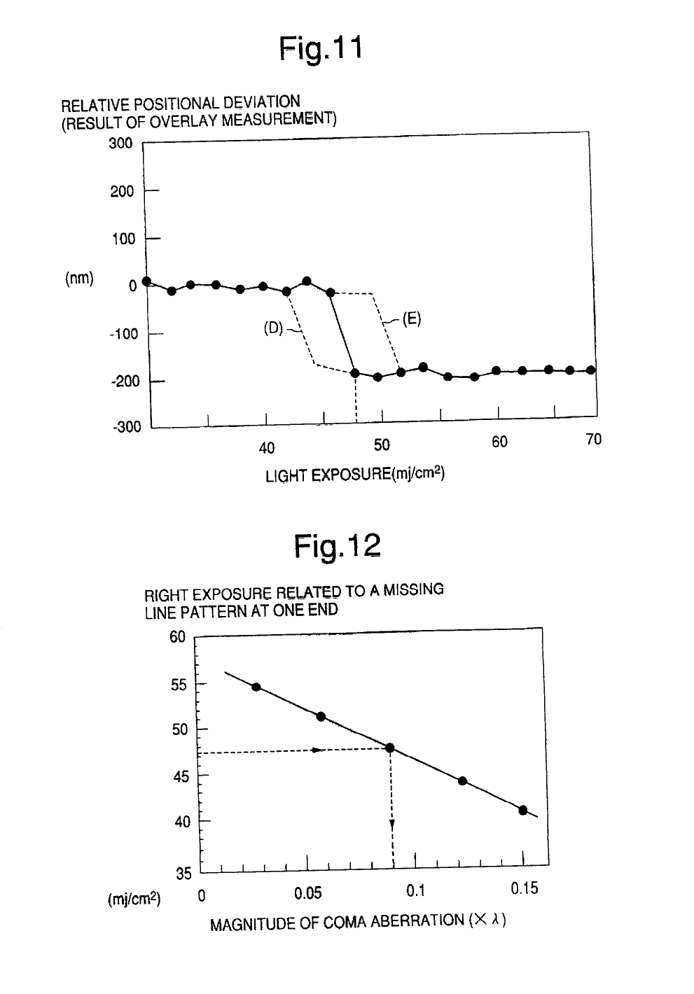

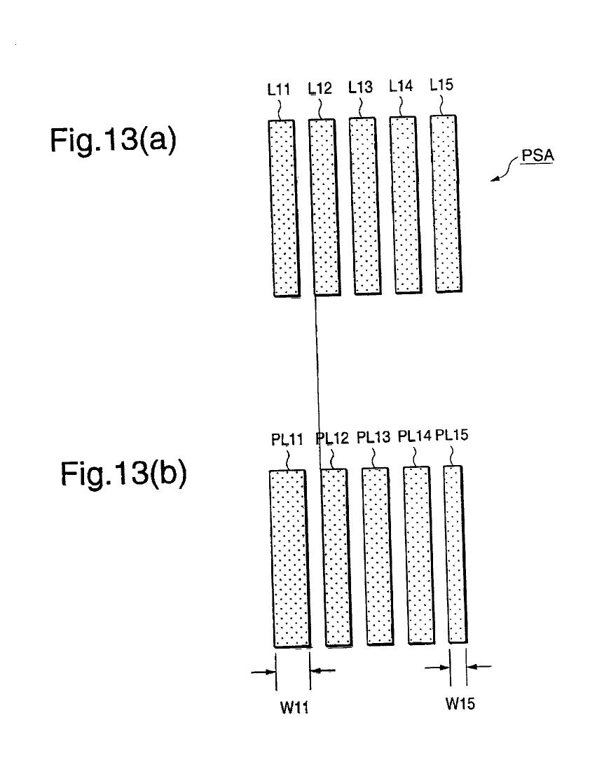

Therefore, like the case of the first embodiment as shown in FIGS. 6(a) and 6(b), the line portion L in the image of an L/S pattern P00 and the center position CL (CL′) of the line portion L in the direction of alignment are measured using an automatic overlay measuring instrument. At the same time, the center position CB of the reference line pair B along the direction of alignment of the line portion L is measured. Then the difference between the measured center position CL (CL′) of the line portion L and the measured center position CB of the reference line pair B, or a relative positional deviation ΔC, is calculated. The result is that, as shown in FIG. 11, when the amount of light exposure is larger than 47 mj/cm² as the critical exposure amount, an image of one of the lines at both ends does not appear, the center position CL′ of the line portion L deviates by one half of a pitch, thus the relative positional deviation ΔC is nearly 200 nm; conversely, when the amount of light exposure is smaller than that, the relative positional deviation ΔC is almost zero. This suggests that the value of coma aberration in the projection optical system 105 depends on the critical exposure as mentioned above. Accordingly, as shown in FIG. 12, after projection exposure is performed to produce images of the above-mentioned L/S pattern, the correlation between coma aberration values and critical light exposures with which an incomplete L/S pattern image PP0 begins to appear should be plotted. This correlation should be determined using a simulator which performs computation for the optical system of the projection exposure device concerned as well as shapes after exposure and development. In other words, using a simulator which computes the optical system, while mathematically varying the light exposure, the level of incident light which causes a specific value of coma aberration is calculated; then an L/S pattern image is defined by means of a simulator which uses the calculated incident light level as an input to calculate shapes after exposure and development; then a graph which shows light exposures for incomplete L/S pattern images versus coma aberration values is plotted as shown in FIG. 12. By applying the critical light exposure as mentioned above to this correlation graph, the value of coma aberration can be obtained.

The critical light exposure for an incomplete L/S pattern image where a line at one end of an L/S pattern line portion L begins to disappear varies depending on the value of coma aberration. In the graph in FIG. 11, for a large coma aberration value, as shown in the correlation represented by broken line D, the critical light exposure is small. Conversely, for a small coma aberration value, as represented by broken line E, the critical light exposure is large. Therefore, by applying the critical light exposures as represented by broken lines D and E to the graph in FIG. 11, different values of coma aberration are obtained.

With the procedures as explained so far, the X component of coma aberration is obtained from sixteen evaluation patterns PX and the Y component of coma aberration is obtained from sixteen evaluation patterns PY. When the above measuring procedures are taken for each of the thirteen evaluation patterns PS made by a shots of exposure, the distribution of coma aberrations within the shot can be used for system adjustment. The lens of the projection optical system is adjusted according to this distribution. For instance, if coma aberrations are radially distributed within a shot, the lens interval in the projection optical system should be adjusted; if coma aberrations are distributed in the same direction, the lens optical axis should be adjusted.

As discussed above, according to the second embodiment of the present invention, coma aberrations can also be obtained just by measuring the relative positional deviation ΔC of the center position CL of the line portion L from the center position CB of the reference line pair B in each L/S pattern PP of transferred images of L/S pattern P00 on the evaluation wafer W. It is not necessary to directly measure the widths of lines L1 to L10 constituting the line portion L of L/S pattern image PP and individual spaces between these lines. Also when measuring line widths, it is unnecessary to use a scanning electronic microscope. For this reason, a coma aberration can be measured more easily. Moreover, there is no need to use phase shift mask or the like making mask manuufacturing process simple. In this aspect, it can be said that this measuring method is simpler than the conventional method.

Since a coma aberration occurs in a radial direction including the optical axis, the direction of alignment of L/S pattern image lines L is not limited to the X or Y direction; it may be rotated by 45 degrees or 22.5 degrees with respect to the X or Y direction.

As can be understood from the above explanation, when the measuring method according to the present invention is used, it is not necessary to measure widths of fine lines constituting a line portion L of L/S pattern and individual spaces between these lines. Also when measuring the dimensions of L/S pattern images, it is unnecessary to use a scanning electronic microscope. For this reason, a coma aberration can be measured more easily without the need for an evaluation mask with a special structure.

It is apparent that the present invention is not limited to the above embodiments, but maybe changed and modified without departing from the spirits and scope of the invention.

What is claimed is:

1. A method of measuring a pattern comprising:
exposing an evaluation pattern having at least two light-impermeable line patterns to form on a target a plurality of transferred patterns each based on said evaluation pattern; and
detecting which one or ones among said transferred patterns is brought into a state that anyone of said two light-impermeable line patterns disappears.

2. The method as claimed in claim 1, wherein a plurality of said evaluation patterns are provided on a:single mask, and said exposing is executed with said single mask to thereby form said plurality of transferred patterns on said object.

3. The method as claimed in claim 2, wherein at least one of said light-impermeable line patterns is different from one another among said evaluation patterns.

4. The method as claimed in claim 3, wherein each of said evaluation patterns has at least one additional light-impermeable line pattern between said two light-impermeable line patterns, and in at least one of said evaluation patterns, each of said two light-impermeable line patterns is different in width from said additional light-impermeable line patterns.

5. The method as claimed in claim 3, wherein said plurality of evaluation patterns are arranged adjacent to one another to constitute a group, and a plurality of said groups are distributed on said mask.

6. The method as claimed in claim 1, wherein said exposing is executed a plurality of times with a mask having said evaluation pattern so that said plurality of transferred patterns are formed on said target.

7. The method as claimed in claim 6, wherein said exposing are executed a plurality of times while varying exposure amount for each exposure.

8. The method as claimed in claim 7, wherein a plurality of ones of said evaluation pattern are formed and distributed on said mask, and the each of said light-impermeable line patterns is identical in width among said evaluation patterns.

9. A method for measuring a coma aberration in an optical system with a projection optical system, the method comprising:
illuminating with light a mask that is provided with a evaluation pattern having at least two light-impermeable line patterns;
leading the light through said mask to said projection optical system and exposing a target with an output from said projection optical system to create on said target a plurality of transferred patterns each based on said evaluation pattern;
detecting which one or ones among said transferred patterns is brought into state that any one of said two light-impermeable line patterns disappears; and
evaluating a coma aberration in said projection optical system according to a result of said detecting.

10. The method as claimed in claim 9, wherein a plurality of said evaluation patterns are provided on said mask and said exposing is executed with said mask to form said plurality of transferred patterns on said target, and at least one of said light-impermeable lines is different from one another among said evaluation patterns.

11. The method as claimed in claim 10, further comprising:
determining a correlation between magnitude of coma aberration belonging to said projection optical system and the line widths of a state where one of said two light-impermeable line patterns disappears,
wherein the magnitude of coma aberration is determined from said correlation and said result of detection.

12. The method as claimed in claim 9, wherein a plurality of transferred patterns are formed on said target by executing said exposing a plurality of times with said mask while varying exposure amount for each exposure.

13. The method as claimed in claim 12, further comprising:
determining a correlation between magnitude of coma aberration belonging to said projection optical system and the light exposures of a state where any one of said two light-impermeable line patterns disappears,
wherein the magnitude of coma aberration is determined from said correlation and said result of detection.

14. A coma aberration measuring method comprising:
placing an evaluation mask on a mask stage of a projection exposure device;
placing an evaluation wafer with a photosensitive film coated on its surface on a wafer stage;
illuminating, with a lighting optical system, said evaluation mask that is provided with an evaluation pattern having at least two line patterns, focusing an image of said evaluation pattern on said evaluation mask onto the surface of said evaluation wafer by means of a projection optical system and exposing it to light;
developing an exposed photosensitive film to form a plurality of transferred patterns on said photosensitive film each based on said evaluation patterns;
distinguishing among said plurality of transferred patterns, between ones having all said line patterns and ones not having; and
determining magnitude of coma aberration from the result of such distinction.

15. The coma aberration measuring method as claimed in claim 14, wherein a plurality of said evaluation patterns are provided on said evaluation mask and at least one of said line patterns is different from one another among said evaluation patterns.

16. The coma aberration measuring method as claimed in claim 15, wherein in each of said evaluation patterns, at least two said line patterns are formed as a line portion between a pair of reference lines; and
wherein in each of said transferred patterns, a relative positional deviation in a direction of line alignment of a center position of said line portion from a center position of said reference line pair is measured and the magnitude of coma aberration is determined based on said relative positional deviation.

17. The coma aberration measuring method as claimed in claim 14, wherein a plurality of transferred patterns are formed by executing said exposing a plurality of times with said evaluation mask while varying exposure amount for each exposure.

18. The coma aberration measuring method as claimed in claim 17, wherein in said evaluation pattern, at least two said line patterns are formed as a line portion between a pair of reference lines;
wherein in each of said transferred patterns a relative positional deviation in a direction of line alignment of a center position of said line portion from a center position of said reference line pair is observed; and
wherein the light exposure used for a transferred pattern in which that relative positional deviation becomes substantial is regarded as a critical exposure and the coma aberration which corresponds to this critical exposure is defined as the coma aberration for said optical system.
